(19) United States
(12) Patent Application Publication
(10) Pub. No.: US 2023/0031162 A1
(43) Pub. Date: Feb. 2, 2023

(54) DEPLOYABLE SHELTER STAIRS

(71) Applicant: Patriot Campers Holdings Pty Ltd, Molendinar (AU)

(72) Inventors: Simon Noel Pearce, Sunnybank Hills (AU); Jack Nelson Beet, Molendinar (AU); Justin Montesalvo, Nerang (AU)

(73) Assignee: Patriot Campers Holdings Pty Ltd, Molendinar (AU)

(21) Appl. No.: 17/867,092

(22) Filed: Jul. 18, 2022

(30) Foreign Application Priority Data
Jul. 30, 2021 (AU) 2021104735

(51) Int. Cl. E04H 15/06; E06C 5/02

(52) U.S. Cl. CPC E04H 15/06; E06C 5/02

(57) ABSTRACT

The present application relates to deployable shelter stairs. The deployable shelter stairs may include stringers and a plurality of treads extending between the stringers. Each tread may be integrally formed from plastic by way of injection molding with no sharp edges such that the treads are more lightweight than metal.

### RELATED APPLICATIONS

This application claims priority to AU 2021104735 filed Jul. 30, 2021, which is hereby incorporated herein by reference.

### TECHNICAL FIELD

The present invention relates to stairs for use in deployable shelters such as roof tents.

### BACKGROUND

The reference to any prior art in this specification is not, and should not be taken as an acknowledgement or any form of suggestion that the prior art forms part of the common general knowledge.

Automotive roof tents are fitted to four wheel drive (4WD) vehicles or camper trailers when camping.

The Applicant's application WO 2018/107196 discloses a roof tent with a novel bedding support. The bedding support includes a sleeping platform, and stairs for pivotally mounting to the sleeping platform.

In practice, the metal stairs have treads with sharp edges which are dangerous for bare feet, and perforations in which a toe could be stuck. Further, the metal stairs are heavy and prone to twisting.

The Applicant has perceived a need for improved deployable shelter stairs.

### SUMMARY OF THE INVENTION

According to one aspect of the present invention, there is provided deployable shelter stairs including: stringers; and treads extending between the stringers.

Each tread may be integrally formed from plastic, preferably by way of injection molding with no sharp edges and being more lightweight than metal. Each tread may include a pair of opposed passages through which the stringers pass to impede twisting of the stairs.

Each tread may include a surface grip pattern to avoid slipping, in place of dangerous perforations. The grip pattern may include a polygonal, and preferably hexagonal pattern. Each tread may include underside strengthening formations or ribbing to be lightweight and strong. The formations or ribbing may be criss-crossed.

The stairs may further include a safety rail for extending from the stairs. The safety rail may be retractable. The safety rail may be pivotally mounted to a stringer. The stairs may further include a mounting bracket for mounting the safety rail. The stairs may further include a lock for locking the safety rail in an extended configuration.

The stairs may include feet at the base of respective stringers. The feet may be non-planar, and preferably rounded. The feet may be formed from softer material than the stringers, preferably rubber.

According to one aspect of the present invention, there is provided a bedding support for a deployable shelter, the bedding support including: the stairs; and a sleeping platform to which the stairs are pivotally mounted.

The sleeping platform and/or stringers may be integrally formed from plastic, preferably by way of extrusion, so that the overall bedding support is lightweight and strong.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1a is an upper front perspective view of deployable shelter stairs in accordance with an embodiment of the present invention;

FIG. 1b is a rear view of the stairs of FIG. 1a;

FIG. 1c is a side view of the stairs of FIG. 1a;

FIG. 1d is a lower perspective view of the top end of the stairs of FIG. 1a;

FIG. 2 is an upper perspective view of an articulated roof tent bedding support including the stairs of FIG. 1a;

FIG. 3 is an upper perspective view of the folded roof tent bedding support of FIG. 2;

FIG. 4a is a plan view of a retractable bedding support for use in forming bedding for a roof tent;

FIG. 4b is a side view of the bedding support of FIG. 4a;

FIG. 4c is a detail view of region Z of the bedding support of FIG. 4b; and

FIG. 4d is an end view of the bedding support of FIG. 4a.

### DETAILED DESCRIPTION OF PREFERRED EMBODIMENTS

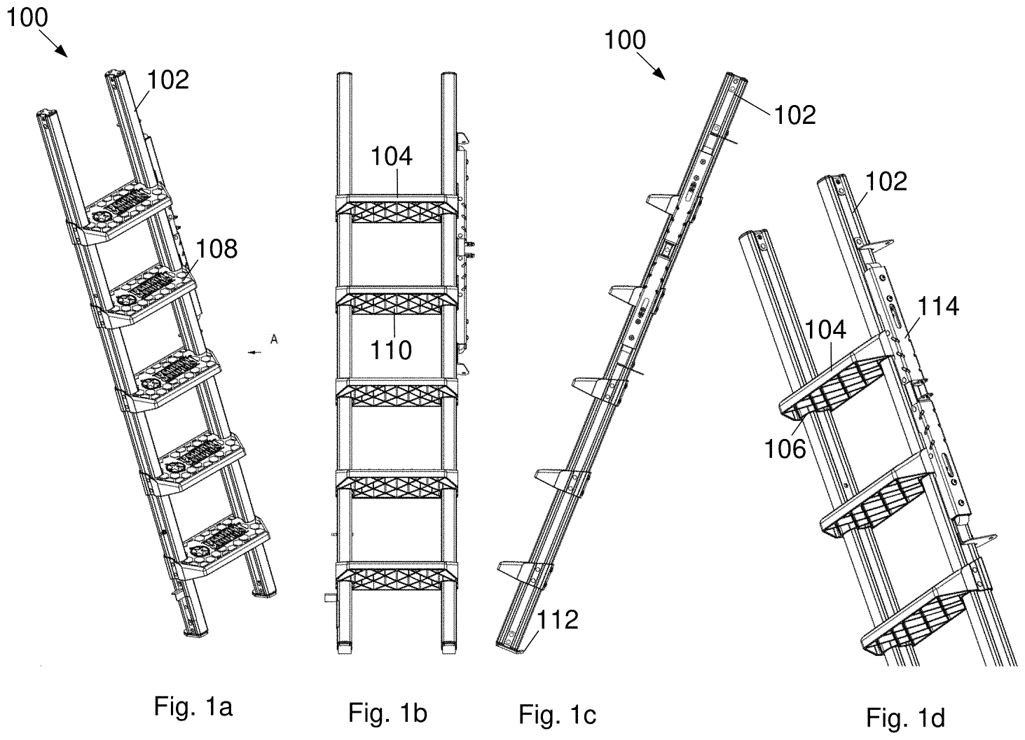

According to one aspect of the present invention, there is provided stairs 100 for a roof tent (i.e. deployable shelter) as shown in FIG. 1.

The stairs 100 include two upright stringers 102, and treads 104 extending between the stringers 102. Each tread 102 is integrally formed from plastic with no sharp edges, by way of injection molding, and is more lightweight than equivalent metal treads. Each tread 102 includes a pair of opposed passages 106 through which respective complementarily-shaped stringers 102 snugly slide and pass to impede twisting of the stairs 100, in use.

Each tread 102 includes a topside surface grip pattern 108 to avoid slipping, in place of dangerous perforations in which toes can undesirably be stuck. The grip pattern 102 is a hexagonal (i.e. polygonal) pattern. Each tread 102 also includes underside strengthening formations 110, in the form of criss-crossed ribbing, to be both lightweight and strong.

The stairs 100 further include feet 112 at the base of respective stringers 102. The non-planar feet 112 are rounded to impede damage to canvas or material flooring, and are also formed from softer material (e.g. rubber) than the stringers 102.

The stairs 100 further include an elongate mounting bracket 114, affixed along a stringer 102, for mounting a pivoting safety rail.

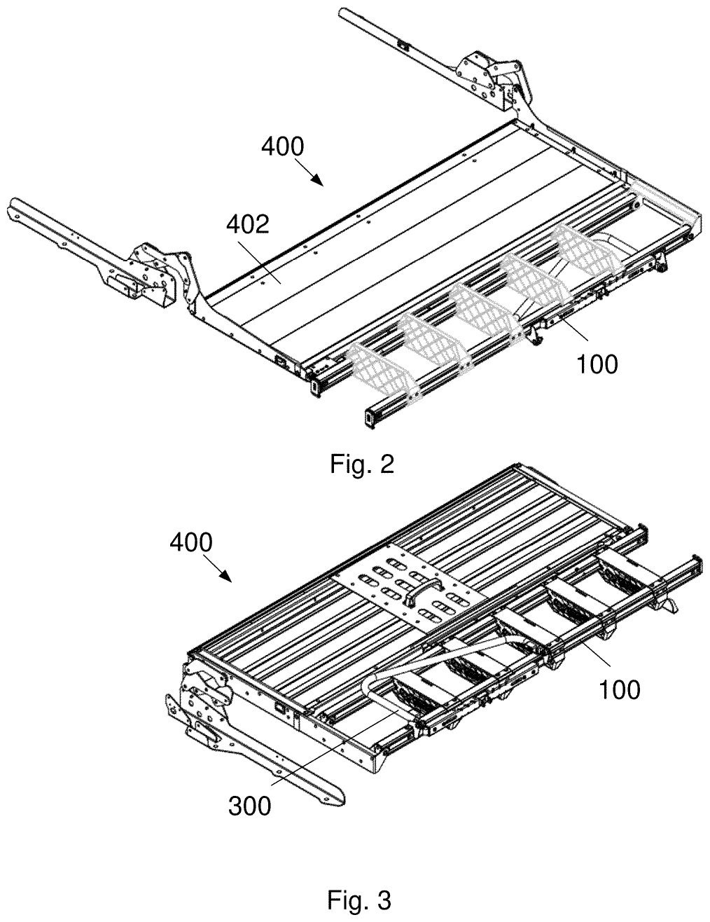

FIGS. 2 and 3 show a retractable bedding support 400 for use in forming bedding for the roof tent, and which can be erected independent of the roof tent. Advantageously, the bedding support 400 can be foldably retracted to make more space within the erected tent as required and unfolded when forming bedding for the roof tent.

The bedding support 400 includes the stairs 100, and a sleeping platform 402 to which the stairs are pivotally mounted. The sleeping platform 402 and stringers are integrally formed from plastic, by way of extrusion, so that the overall bedding support 400 is lightweight and strong, making it much easier for use. The sleeping platform 402 is solid, with no perforations, to avoid condensation in the tent.

As can best be seen in FIG. 3, the stairs 100 further include a retractable safety rail 300 for pivoting to extend from the stairs 100. The stairs 100 also include a two-finger lock, with two pin-in-hole arrangements, for locking the safety rail in the retracted configuration of FIG. 3 and an extended configuration.

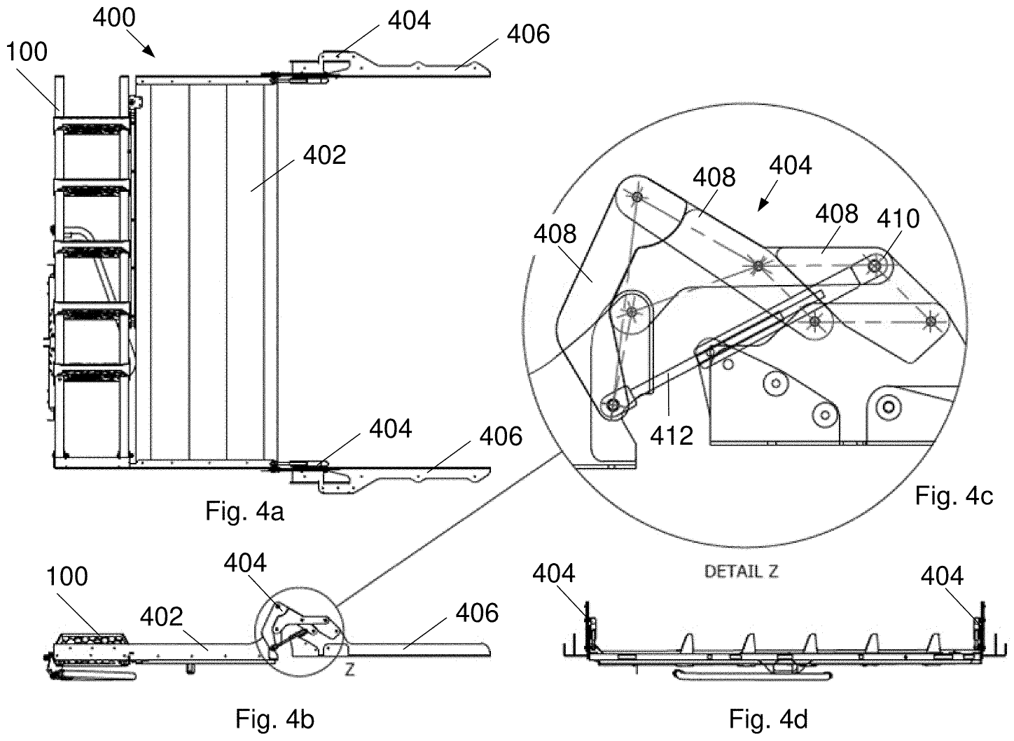

Turning to FIG. 4, the articulated bedding support 400 includes a sleeping platform 402 coupled to a pair of flexible joints 404. The bedding support 400 further includes a pair of support arms 406 coupled to respective flexible joints 404.

Each flexible joint 404 includes pivotally coupled bar members 408 to enable angular movement of the sleeping platform 402 through at least 180 degrees, and out past the sealing face of a tent lid. The four-bar low-profile flexible joint 404 made from tub deburred strainless steel is of low width, which advantageously allows for a wider bed base and enabled removal of a notch in a tent sealing extrusion for better sealing against dust and water. The pivot locations 410 on the members 408 be adjusted to alter the angular movement of the sleeping platform 402.

The bedding support 400 also includes a damper 412, in the form of a ram or gas strut, to dampen the movement of the bedding support 402. In particular, the damper 412 is arranged to impede slamming down of the sleeping platform 402 from a vertical to horizontal configuration. The bedding support 400 also includes one or more electrical, pneumatic or hydraulic actuators for actuating respective flexible joints 402 to move the bedding support 402.

The bedding support 400 further includes the retractable stairs 100 pivotally coupled to the sleeping platform 402. The stairs 100 pivot to be coplanar with the sleeping platform 402, thereby effectively extending the platform 402. The stairs 100 angularly move up and down in a plane perpendicular to a plane of angular movement of the sleeping platform 402.

A person skilled in the art will appreciate that many embodiments and variations can be made without departing from the ambit of the present invention.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A deployable shelter stairs including:
stringers; and
treads extending between the stringers.

2. The deployable shelter stairs as claimed in claim 1, wherein each tread is integrally formed from plastic.

3. The deployable shelter stairs as claimed in claim 1, wherein each tread is integrally formed by way of injection molding with no sharp edges and being more lightweight than metal.

4. The deployable shelter stairs as claimed in claim 1, wherein each tread includes a pair of opposed passages through which the stringers pass to impede twisting of the stairs.

5. The deployable shelter stairs as claimed in claim 1, wherein each tread includes a surface grip pattern to avoid slipping, in place of dangerous perforations.

6. The deployable shelter stairs as claimed in claim 5, wherein the grip pattern includes a polygonal pattern.

7. The deployable shelter stairs as claimed in claim 5, wherein the grip pattern includes a hexagonal pattern.

8. The deployable shelter stairs as claimed in claim 1, wherein each tread includes underside strengthening formations or ribbing to be lightweight and strong.

9. The deployable shelter stairs as claimed in claim 8, wherein the formations or ribbing is criss-crossed.

10. The deployable shelter stairs as claimed in claim 1, wherein the stairs further include a safety rail for extending from the stairs.

11. The deployable shelter stairs as claimed in claim 10, wherein the safety rail is retractable.

12. The deployable shelter stairs as claimed in claim 11, wherein the safety rail is pivotally mounted to a stringer.

13. The deployable shelter stairs as claimed in claim 10, wherein the stairs further include a mounting bracket for mounting the safety rail.

14. The deployable shelter stairs as claimed in claim 10, further including a lock for locking the safety rail in an extended configuration.

15. The deployable shelter stairs as claimed in claim 10, further including feet at the base of respective stringers.

16. The deployable shelter stairs as claimed in claim 15, wherein the feet are non-planar and/or rounded.

17. The deployable shelter stairs as claimed in claim 15, wherein the feet are formed from softer material than the stringers.

18. A bedding support for a deployable shelter, the bedding support including:
the deployable shelter stairs of claim 1; and
a sleeping platform to which the stairs are pivotally mounted.

19. The bedding support as claimed in claim 18, wherein the sleeping platform and/or stringers are integrally formed from plastic, by way of extrusion, so that the overall bedding support is lightweight and strong.

20. A deployable shelter stairs including:
a pair of stringers; and
a plurality of treads extending between the stringers, each tread integrally formed from plastic by way of injection molding with no sharp edges and being more lightweight than metal,
wherein each tread includes a pair of opposed passages, each passage bounding a respective one of the pair of stringers so as to impede twisting of the stairs when in use, and
wherein the stairs form part of a deployable shelter.
